(19) United States
(12) Patent Application Publication
(10) Pub. No.: US 2014/0112486 A1
(43) Pub. Date: Apr. 24, 2014

(54) Tube Amplifier Emulator

(71) Applicant: Shengchao Alfred Li, Potomac, MD (US)

(72) Inventor: Shengchao Alfred Li, Potomac, MD (US)

(21) Appl. No.: 13/657,848

(22) Filed: Oct. 22, 2012

(51) Int. Cl. H04R 3/00

(52) U.S. Cl. CPC H04R 3/00
USPC 381/61

(57) ABSTRACT

This disclosure shows methods and apparatus to emulate vacuum tube amplifiers that have output transformers, to deliver “tube sound”, where the output transformer nonlinearity is emulated. Prior arts that emulated vacuum tube amplifiers either did not include output transformer nonlinearity in their emulation, or did not do it correctly. The disclosed methods and apparatus have the advantage of low cost and flexibility, because the output transformers are included in the emulation.

### BACKGROUND OF THE INVENTION

1. Field of the Invention

This invention is in general related to audio systems, and in particular related to methods and apparatus to alter audio signals to produce the type of soft and euphonic sound typically produced by vacuum tube amplifiers.

2. Brief Description of the Related Prior Art

The first group of prior arts are vacuum tube amplifiers, which include high-end audio amplifier and music instrument amplifiers. The second group of prior arts are circuits invented by people to mimic the “tube sound” with solid state equipments. The third group of prior arts are circuits invented by people to protect loudspeaker cones from over excursion.

It has long been claimed by some audiophils and musicians that tube amplifiers sound better than solid-state amplifiers. The sound produced by tube amplifiers are described as “clean”, “soft”, “smooth”, “fat”, “detailed”, “enphonic”, “life like”,“vivid”, etc. It is sometimes described as “tube sound”. People developed theories to explain the causes of tube sound. Some representative publications are, “The Cool Sound of Tubes”, Spectrum, IEEE, August 1998; “Tubes Versus Transistors: Is There an Audible Differences?” by Russell O. Hamm, Journal of the Audio Engineering Society, May 1973, Volume 21, Number 4, page 267-273; “Tubes verses transistors in electric guitar amplifiers”, W. Stephen Bussey, IEEE International Conference on ICASSP '81. April 1981, Volume: 6, page 800-803.

I published a paper “Why Do Tube Amplifiers Have Fat Sound while Solid State Amplifiers Don't”, Audio Engineering Society Convention 131, Oct. 20-23, 2011, New York, Paper Number:8536. It is referred as “my AES paper” in this application. In that paper, I found that the frequency dependent transformer nonlinear distortion may contribute to the tube sound. In said paper, I described flowcharts on how to emulate tube amplifiers with circuits without the output transformer.

Beyond the tube amplifiers themselves, there are other prior arts related to producing the tube sound. I describe some of them as follows.

In U.S. Pat. No. 5,802,182, Prichard teaches a method to emulate the output transformer. He observed that output transformer selectively attenuate low frequency signals while leave high frequency signals almost untouched. With his method, When both low frequency signals and high frequency signals are applied separately, his method can softly clip low frequency signal and leave the high frequency signal largely untouched. However, when the two kind of signals are applied together, the soft clipping of the low frequency signal affects the superposed high frequency signal, introducing unwanted intermodulation.

In US patent application US2004/0070438A1, Ohshima pointed out such a problem of conventional limiter. Though Prichard's distortion means is “soft” other than “hard” as the conventional limiter that Ohshima wanted to fix, it had similar problem as large amplitude low frequency soft clipping will affect the high frequency signal.

In U.S. Pat. No. 4,113,983, Steel teaches a way to limit the amplitude of movement of the loudspeaker cone. He used a variable high frequency filter. He used a threshold means to determine whether there is a need to raise the breakpoint frequency of the high frequency filter. When there is a need, he rapidly increase the breakpoint frequency so low frequency frequency will be attenuated more; while there is no need, he slowly decrease the breakpoint frequency to the rest frequency.

In U.S. Pat. No. 4,327,250, Von Rechlinghausen teaches a way to protect the loudspeaker from damaging. He used filter, rectifier-smoother and a threshold to detect whether there is a need to modify the signal to prevent loudspeakers from damaging.

In US patent application US2005/0207584, Bright tought

In U.S. Pat. No. 5,481,617, Bjerre re-arranged Von Rechlinghausen's circuit, basically combine the variable high-pass filter and the low-pass control filter to make a band-pass filter, and added a high-pass filter to undo the low-pass control filter to produce the output. He removed the smoother to make the response instantaneous.

In U.S. Pat. No. 5,528,695 (FIG. 7) Klippel used a linear filter which follows the loudspeaker characteristic, followed by an envelop detector to generate control signal which anticipate the signal peak. The control signal is smoothed by a leakage integrator which have a short time constant for the attack slope and a long time constant for the decay to avoid audible modulation of the audio signals by the control signal. If the peak exceeds a threshold, the input signal is attenuated to prevent loudspeaker overload. He has both feed-forward and feed-back configurations.

In U.S. Pat. No. 5,577,126 (FIG. 8), Klippel used a linear filter H_{X} to monitor the loudspeaker load, and if the load exceed a threshold, the controller C will activate the feedback loop to attenuate the input signal. Note that the control signal is again smoothed by a leakage integrator which have a short time constant for the attack slope and a long time constant for the decay to avoid audible modulation of the audio signals by the control signal.

In US patent application US2005/021573 A1 (FIG. 10), Poletti uses a feedback system to control the bandwidth of an amplifier according to the level of the input signal. He required the filter H(s) to have at least a low pass filter, so it looks like his purpose was to change the bandwidth from the up side of the audible bandwidth. However, if the filter H(s) also have a high pass filter component, as one of his examples shows, the system is capable to attenuate the low frequency signal too. This makes his patent closely related to Kohut's patent. One difference is where the output signal is taken. In Poletti's patent the output signal is after the filter H(s), while in Kohut's patent the output signal is combined from signals taken both before and after the filter. The parameters of the filter H(s) need to be different too.

### BRIEF SUMMARY OF THE INVENTION

It is well known that transformer core saturation causes distortion for low frequency audio signals. It is little known that this distortion probably is the cause of the “clean”, “soft” or “smooth” property of the tube sound.

It is known that the speaker cone excursion is reversely proportional to signal frequency. Referring to said my AES paper, it is clear that a typical tube amplifier acts like a frequency selective nonlinear feedback system that softly limits the speaker cone excursion for low frequency music signal with excessive amplitude, but has little effect on high frequency music signal or low frequency music signal with low to moderate amplitude. Better yet, at least for one direction of the signal polarity, when low frequency music signal with excessive amplitude is superposed with high frequency music signal, tube amplifiers selectively limit low frequency music signal and has little effect on the high frequency music signal.

Upon studying the tube amplifier, I come up with simple models of tube amplifiers, including models of output transformers, which is readily implemented without having to use bulky out put transformers found in typical vacuum tube amplifiers.

People have long come up with inventions to softly limit the excursion of speaker cones. The prior arts described are just some representative ones. However, because those prior arts were not derived from emulating a real vacuum tube amplifier, there are important difference between the present invention and the prior arts. One important one is that the present invention has a feedback paths for both the voltage and current of the speakers while the prior arts don't. One other difference is that with the prior arts, the quality of the sound produced by speakers are unknown. With the present invention, one can have a real vacuum tube amplifier measured, the vacuum tube nonlinearity and transformer iron core nonlinearity modelled, and an emulator constructed to precisely reproduce the sound of the real vacuum tube amplifier. The method of modelling is disclosed in said my AES paper. Further more, some drawbacks associated with real vacuum tube amplifiers can be remedied in the emulator. For example, hum can be completely removed from the emulator. New nonlinearity models that are not yet existing in vacuum tubes or transformer core irons can be introduced into the emulator, to produce audio effects that is not yet exploited with existing vacuum tube amplifiers.

The object of the present invention is to provide novel methods and apparatus to emulate a vacuum tube amplifier, without having to use output transformers.

Since the current invention has the capability to softly limit the excursion of speaker cones, it has the effect of protecting speakers from damages caused by excessive cone excursion.

### BRIEF DESCRIPTION OF THE DRAWINGS

FIG. 1 illustrates a typical single ended triode amplifier, according to the prior art.

FIG. 2 illustrates Pritchard's transformer emulator, according to the prior art.

FIG. 3 illustrates Bright's loudspeaker displacement limiter, according to the prior art.

FIG. 4 illustrates Holman's loudspeaker protector, according to the prior art.

FIG. 5 illustrates Steel's filtering apparatus for loudspeakers, according to the prior art.

FIG. 6 illustrates Von Recklinghausen's dynamic loudspeaker equalizer, according to the prior art.

FIG. 7 illustrates Klippel's loudspeaker protector, according to the prior art.

FIG. 8 illustrates Klippel's another loudspeaker protector, according to the prior art.

FIG. 9 illustrates Kohut's loudspeaker excursion limiter, according to the prior art.

FIG. 10 illustrates Poletti's amplifier with distortion effects, according to the prior art.

FIG. 11 illustrates Bjerre's amplifier with frequency dependent amplitude regulation, according to the prior art.

FIG. 12(A-C) illustrates examples of proportional adder/subtracter, according to the present invention.

FIG. 13 illustrates the symbol of a triode or triode emulator.

FIG. 14 (A) illustrates the symbol of bass low pass filter, according to the present invention.

FIG. 14 (B-E) illustrates frequency responses of some example filters that are bass low pass filters, according to the present invention.

FIG. 14 (F-H) illustrates the implementation of some example filters that are bass low pass filters, according to the present invention.

FIG. 15 (A) illustrates the symbol of bass high pass filter, according to the present invention.

FIG. 15 (B-E) illustrates frequency responses of some example filters that are bass high pass filters, according to the present invention.

FIG. 15 (F-H) illustrates the implementation of some example filters that are bass high pass filters, according to the present invention.

FIG. 16 (A) illustrates the symbol of type 1 expander, according to the present invention.

FIG. 16 (B) illustrates the output-input relation ship of a type 1 expander, according to the present invention.

FIG. 16 (C-D) illustrate examples of type 1 expander, according to the present invention.

FIG. 17 (A) illustrates the symbol of type 1 compressor, according to the present invention.

FIG. 17 (B) illustrates the output-input relation ship of a type 1 compressor, according to the present invention.

FIG. 17 (C-D) illustrate examples of type 1 compressor, according to the present invention.

FIG. 18 (A) illustrates the symbol of type 2 compressor, according to the present invention.

FIG. 18 (B-C) illustrates the output-input relationship of type 1 compressors, according to the present invention.

FIG. 18 (D-E) illustrate examples of type 2 compressor, according to the present invention.

FIG. 19 (A) illustrates the symbol of type 2 expander, according to the present invention.

FIG. 19 (B-C) illustrates the output-input relationship of a type 2 expander, according to the present invention.

FIG. 19 (D-E) illustrate examples of type 3 expander, according to the present invention.

FIG. 20 (A) illustrates the symbol of type 3 expander, according to the present invention.

FIG. 20 (B) illustrates an example of type 3 expander, according to the present invention.

FIG. 21 (A) illustrates the symbol of type 3 compressor, according to the present invention.

FIG. 21 (B) illustrates an example of type 3 compressor, according to the present invention.

FIG. 22 (A) illustrates the symbol of voltage driver, according to the present invention.

FIG. 22 (B) illustrates an example of voltage driver, according to the present invention.

FIG. 23 (A) illustrates the symbol of current driver, according to the present invention.

FIG. 23 (B) illustrates an example of current driver, according to the present invention.

FIG. 24 (A) illustrates the symbol of type 1 Rp/Power supply emulator, according to the present invention.

FIG. 24 (B) illustrates an examples of type 1 Rp/Power supply emulator, according to the present invention.

FIG. 25 (A) illustrates the symbol of type 2 Rp/Power supply emulator, according to the present invention.

FIG. 25 (B-C) illustrate examples of type 2 Rp/Power supply emulator, according to the present invention.

FIG. 26 illustrate block diagram of the invented tube amplifier emulator, according to the current invention. It was disclosed in my said AES paper.

FIG. 27 illustrates an example implementation of the block diagram illustrated in FIG. 26, according to the present invention.

FIG. 28 (A-B) illustrate the first preferred embodiment of said tube amplifier emulator, according to the present invention.

FIG. 29 (A-B) illustrate the second preferred embodiment of said tube amplifier emulator, according to the present invention.

FIG. 30 illustrates the third preferred embodiment of said tube amplifier emulator, according to the present invention.

FIG. 31 (A)-B) illustrate the fourth preferred embodiment said tube amplifier emulator, according to the present invention.

FIG. 32 illustrates fifth preferred embodiment said tube amplifier emulator, according to the present invention.

### DETAILED DESCRIPTION OF THE INVENTION

### Analysis of the Triode Amplifier

### Terms

Throughout the specification and claims, the following terms take at least the meanings explicitly associated herein, unless the context clearly dictates otherwise. The meanings identified below are not intended to limit the terms, but merely provide illustrative examples for use of the terms.

The term “coupled” can mean a direct connection between items, an indirect connection through one or more intermediaries, or communication between items in a manner that may not constitute a physical connection.

The term “circuit” can mean a single component or a plurality of components, active and/or passive, discrete or integrated, that are coupled together to provide a desired function.

The term “signal” can mean at least one current, voltage, charge, data, or other such identifiable quantity. A voltage signal can mean such identifiable quantity that represent a voltage and itself is not necessarily in the form of a voltage. A current signal can mean such identifiable quantity that represent a current and itself is not necessarily in the form of a current.

Signal A is “proportional” to signal B may mean the AC part of signal A is substantially proportional to the AC part of signal B. The proportion coefficient may be positive or negative or zero. When signal A is proportional to signal B, signal B is also proportional to signal A.

Signal A is “equivalent” to signal B may mean the AC part of signal A substantially equals to the AC part of signal B.

A port is where signal is coupled to a circuit. A port can be an input port, an output port, or a port that is both input port and output port. Some times a port is just called a port, without mention its type.

Signal A “contains” signal B means there signal A has information about signal B, and signal B can be recovered from signal A if needed, possibly by processing signal A with other signals. For example, if voltage signal A is a summation of voltage signal B and voltage signal C, then signal A contains signal B, because later on signal B can be recovered by subtracting signal C from signal A. For another example, signal A contains signal A itself. This term specify only the relationship between signals by value, it does not limit which signal drives the other.

A “weighted summation” of two or more input signals is a signal that is a summation of each of the input signals, each with a proportion coefficient that can be positive or negative, respectively.

### Proportional Adder/Subtracter

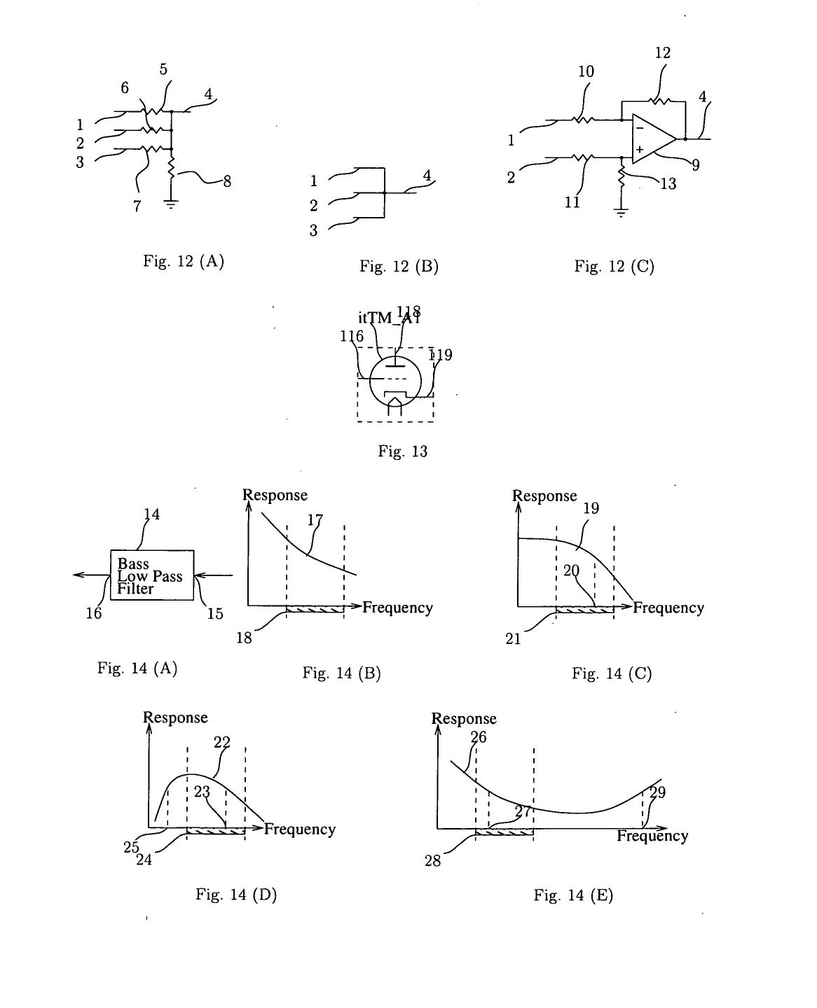

FIG. 12 (A-C) illustrate some examples of proportional adder/subtracters. A proportional adder/subtracter has at least a first input port 1, a second input port 2, optionally other input ports, such as 3, and an output port 4 where the signal at said output port 4 is a weighted summation of signals received from said first input port 1, said second input port 2, and said optionally other input ports, such as said port 3. The weighting coefficients may individually be positive or negative.

In FIG. 12 (A), a resistor network is used to proportionally sum up voltages at the input ports, each with a corresponding coefficient. A first input port 1 is connected to an output port 4 through resistor 5. A second input port 2 is connected to said output port 4 through resistor 6. An input port 3 is connected to said output port 4 through resistor 7. Said output port 4 is connected to ground through resistor 8. The output voltage at said output port 4 is a weighted summation of the input voltages at said first input port 1, said second input port 2 and said input port 3.

In FIG. 12 (B), a first input port 1 is connected to an output port 4. A second input port 2 is connected to said output port 4. An input port 3 is connected to said output port 4. The input currents at said first input port 1, said second input port 2 and said input port 3 are added up and sent to said output port 4.

In FIG. 12 (C), a first input port 1 is connected to the negative input port of an operational amplifier 9 through resistor 10. A second input port 2 is connected to the positive input port of an operational amplifier 9 through resistor 11. The negative input port of said operational amplifier 9 is connected to the output port of said operational amplifier 9 through resistor 12. The positive input port of said operational amplifier 9 is connected to ground through resistor 13. The voltage at an output port 4 is proportional to the weighted summation of the voltages at said first input port 1 and said second input port 2, each with a proportion coefficient, respectively. The proportion coefficient for voltage at said first input port 1 is negative while the proportion coefficient for voltage at said second input port 2 is positive.

### Triode or Triode Emulator

Triodes have specific nonlinearities of their own, So triodes can he used for their nonlinearity. When triode is not available, or is not appreciated for any reasons, a triode emulator can be used instead. For example, a pentode can be wired to behave like a triode. For example, the screen and grid can be connected together so that the pentode will behavior like a triode. A transistor or FET can be wired such that the collector (transistor) or drain (FET) has feedbacks to the base (transistor) and grid (FET), so that a transistor or FET will behave like triode.

### Bass Low Pass Filter

Let me first define bass frequency range. Because speaker distortion is mostly produced by low frequency signals in the audio frequency range, we are interested in the low frequency range of the audio frequency range. We call such a low frequency range bass frequency range, which is typically, and is not limited to, 20 Hz to 200 Hz. For example, for one audio processing system, such a range might be from 50 Hz to 250 Hz. For another one, it might be from 15 Hz to 100 Hz.

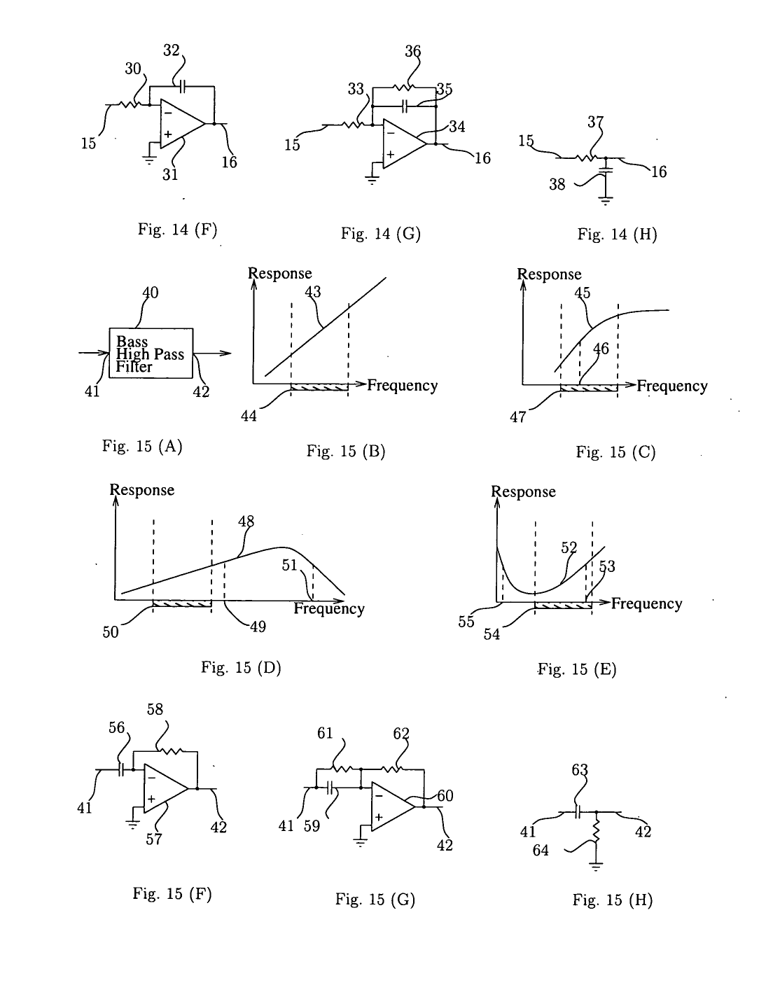

FIG. 14 (A) illustrates the symbol of a bass low pass filter 14. Said bass low pass filter 14 has at least an input port 15 and an output port 16. Said bass low pass filter 14 receives an input signal from the input port 15 and produces an output signal to the output port 16 such that in the majority part of said bass frequency range, for a fixed input amplitude, the higher the input frequency is, the lower the output amplitude is.

FIG. 14 (B) illustrates the frequency response of an integrator. An integrator has frequency response 17 reversely related to the frequencies of the input signal, for any frequencies, including those in the bass frequency range 18. Thus an integrator is a bass low pass filter.

FIG. 14 (C) illustrates the frequency response 19 of a low pass filter. The cut off frequency 20 is not much higher than said bass frequency range 21, thus the frequency response is reversely related to the frequencies of the input signal, and this low pass filter is a bass low pass filter.

FIG. 14 (D) illustrates the frequency response 22 of a band pass filter. The upper cut off frequency 23 is not much higher than said bass frequency range 24, and the lower cut off frequency 25 is low enough, thus in said low frequency range 24, the frequency response is reversely related to the frequencies of the input signal, and this band pass filter is a bass low pass filter.

FIG. 14 (E) illustrates the frequency response 26 of a band reject filter. The lower cut off frequency 27 is not much lower than said bass frequency range 28, and the upper cut off frequency 29 is high enough, thus in said low frequency range 28, the frequency response is reversely related to the frequencies of the input signal, and this band reject filter is a bass low pass filter.

FIG. 14 (F) illustrates an example of the bass low pass filter. The input port 15 is coupled to one port of a resistor 30. The other port of said resistor 30 is coupled to the negative input port of an operational amplifier 31. Said negative input port of said operational amplifier 31 is coupled to one port of a capacitor 32. The other port of said capacitor 32 is coupled to the output port of said operational amplifier 31. The positive input port of said operational amplifier 31 is grounded. Said output port of said operational amplifier 31 is coupled to the output port 16. This is an integrator circuit that has the frequency response reversely related to the frequencies of the input signal. Thus this circuit acts as bass low pass filter.

FIG. 14 (G) illustrates another example of the bass low pass filter. The input port 15 is coupled to one port of a resistor 33. The other port of said resistor 33 is coupled to the negative input port of an operational amplifier 34. Said negative input port of said operational amplifier 34 is coupled to one port of a capacitor 35. The other port of said capacitor 35 is coupled to the output port of said operational amplifier 34. Said negative input port of said operational amplifier 34 is coupled to one port of a resistor 36. The other port of said resistor 36 is coupled to the output port of said operational amplifier 34. The positive input port of said operational amplifier 34 is grounded. Said output port of said operational amplifier 34 is coupled to the output port 16. This is a low pass filter circuit. If the cut off frequency is chosen not to be much higher than said bass frequency range, This circuit acts as bass low pass filter.

FIG. 14 (H) illustrates yet another example of the bass low pass filter. The input port 15 is coupled to one port of a resistor 37. The other port of said resistor 37 is coupled to the first port of a capacitor 38. The other port of said capacitor 39 is grounded. The first port of said capacitor 38 is coupled to the output port 16. This is an integrator circuit thus acts as bass low pass filter.

### Bass High Pass Filter

FIG. 15 (A) illustrates a bass high pass filter 40. Bass high pass filter 40 has at least an input port 41 and an output port 42. A bass high pass filter 40 receives an input signal from the input port 41 and produces an output signal to the output port 42 such that in the majority part of said bass frequency range, for a fixed input amplitude, the higher the input frequency is, the higher the output amplitude is.

FIG. 15 (B) illustrates the frequency response of a differentiator. A differentiator has frequency response 43 positively related to the frequencies of the input signal, for any frequencies, including those in the bass frequency range 44. Thus a differentiator is a bass high pass filter.

FIG. 15 (C) illustrates the frequency response 45 of a high pass filter. The cut off frequency 46 is not much lower than said bass frequency range 47, thus the frequency response is positively related to the frequencies of the input signal, and this high pass filter is a bass high pass filter.

FIG. 15 (D) illustrates the frequency response 48 of a band pass filter. The lower cut off frequency 49 is not much lower than said bass frequency range 50, and the upper cut off frequency 51 is high enough, thus in said low frequency range 50, the frequency response is positively related to the frequencies of the input signal, and this band pass filter is a bass high pass filter.

FIG. 15 (E) illustrates the frequency response 52 of a band reject filter. The upper cut off frequency 53 is not much higher than said bass frequency range 54, and the lower cut off frequency 55 is low enough, thus in said low frequency range 54, the frequency response is positive related to the frequencies of the input signal, and this band reject filter is a bass high pass filter.

FIG. 15 (F) illustrates an example of the bass high pass filter. The input port 41 is coupled to one port of a capacitor 56. The other port of said capacitor 56 is coupled to the negative input port of an operational amplifier 57. Said negative input port of said operational amplifier 57 is coupled to one port of a resistor 58. The other port of said resistor 58 is coupled to the output port of said operational amplifier 57. The positive input port of said operational amplifier 57 is grounded. Said output port of said operational amplifier 57 is coupled to the output port 42. This is a differentiator circuit that has the frequency response positively related to the frequencies of the input signal. Thus this circuit acts as bass high pass filter.

FIG. 15 G illustrates another example of the bass high pass filter. The input port 41 is coupled to one port of a capacitor 59. The other port of said capacitor 59 is coupled to the negative input port of an operational amplifier 60. Said input port 41 is also coupled to one port of a resistor 61. The other port of said resistor 61 is coupled to said negative input port of said operational amplifier 60. Said negative input port of said operational amplifier 60 is coupled to one port of a resistor 62. The other port of said resistor 62 is coupled to the output port of said operational amplifier 60. The positive input port of said operational amplifier 60 is grounded. Said output port of said operational amplifier 60 is coupled to the output port 42. This is a high pass filter circuit. If the cut off frequency is chosen not to be much lower than said bass frequency range, This circuit acts as bass high pass filter.

FIG. 15 (H) illustrates yet another example of the bass high pass filter. The input port 41 is coupled to one port of a capacitor 63. The other port of said capacitor 63 is coupled to the first port of a resistor 64. The other port of said resistor 65 is grounded. Said first port of said resistor 64 is coupled to the output port 42. This is a differentiator circuit circuit so acts as bass high pass filter.

### Type 1 Expander

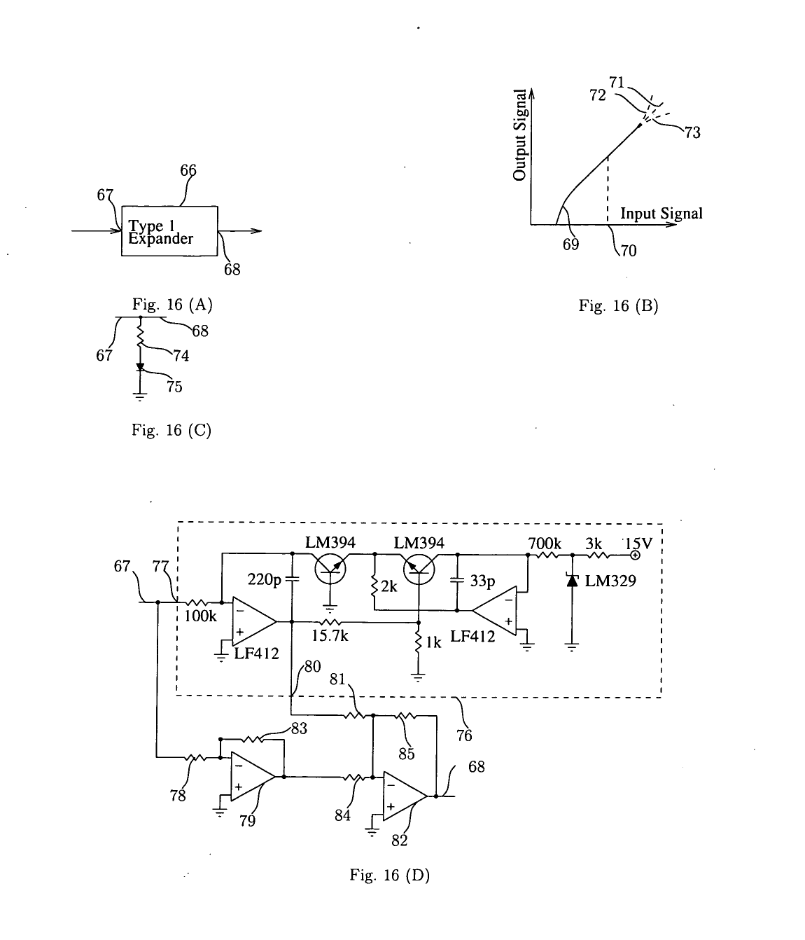

FIG. 16 (A) illustrates a type 1 expander 66. Said type 1 expander 66 has at least one input port 67 and one output port 68. The relationship between the output signal taken from said output port 68 and the input signal fed into said input port 67 is that, at least on one extreme of the operation range of said type 1 expander, when said input signal changes away from the operation point of said type 1 expander, the absolute value of the rate of change of said output signal monotonously increases. It is not required that it strictly increases. FIG. 16 illustrates an example of the relationship between said output signal and said input signal, depicted as a function curve. Denote it the type 1 expander curve. In FIG. 16 (B), 69 is near said extreme of the operation range, which shows that when said input signal decreases from the operation point 70, the absolute value of the rate of change of said output signal monotonously increases (The slop of the function curve becomes steeper). It does not matter how the function curve looks like at the opposite extreme. It can look like, for example, 71,72,73, or other shapes. It is not required that a substantial portion of the function curve near operation point is linear. The function curve is preferably smooth. It is noted that if said input signal or said output signal or both, of the function curve, are added with fixed values, are negated, or are manipulated with the combination of the two, the resulted function curves are still type 1 expander curves, and the type 1 expander is still a type 1 expander.

FIG. 16 (C) illustrates an example circuit of said type 1 expander. The input current signal is fed into the input port 67 of said circuit. The output port 68 of said circuit produces output voltage signal. Said input port 67 is coupled to one port of a resistor 74. The other port of said resistor 74 is coupled to the positive port of a diode 75. The negative port of said diode 75 is grounded. Said input port 67 is also coupled to the output port 68. When said input current signal is large, said diode 75 is almost fully conductive, so said output voltage signal is essentially said input current signal times the value of said resistor 74 plus voltage drop of said diode 75 (usually around 0.6V for silicon diodes). When said input current signal decreases, the rate of decreasing of said output voltage signal increases. Thus this circuit acts as a type 1 expander.

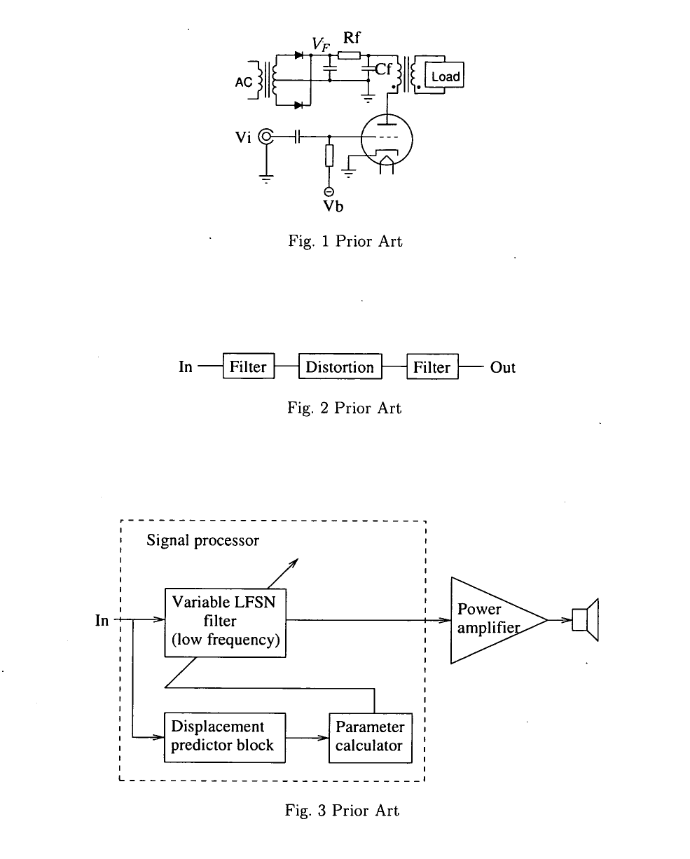

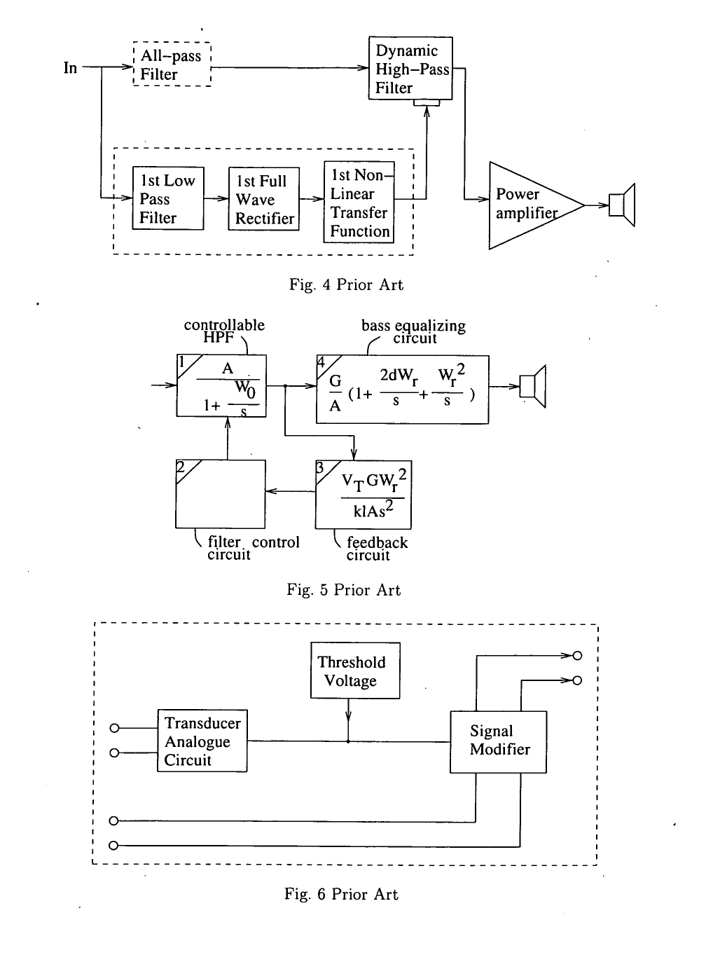

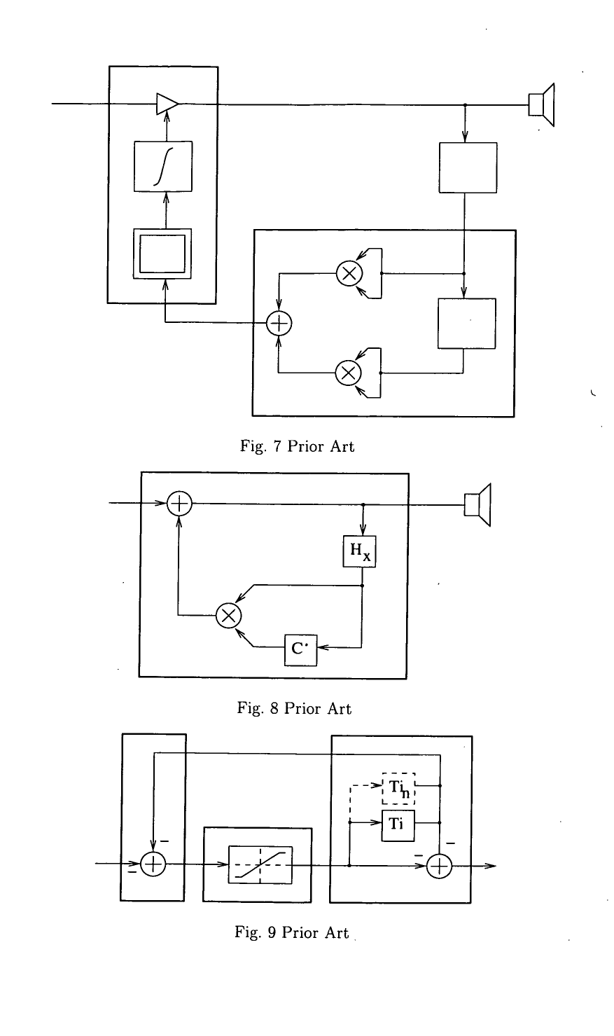

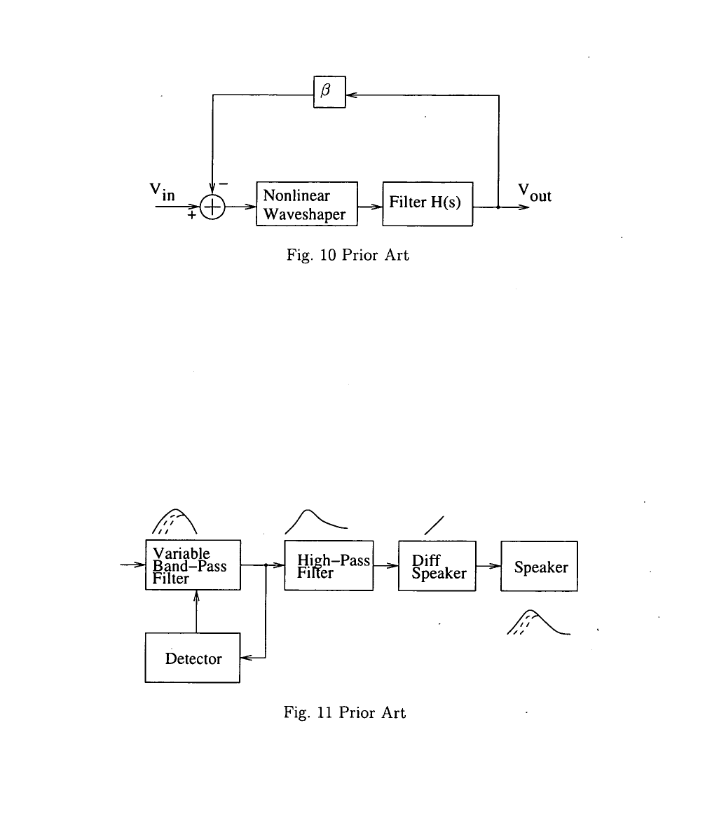

FIG. 16 (D) illustrates another example circuit of said type 1 expander. The input signal is fed into the input port 67. The output signal is taken from the output port 68. The logarithm amplifier 76 is a logarithm circuit taken from FIG. 1 of National Semiconductor Application Note 311, “Theory and Application of Logarithmic Amplifiers”. It is referred as “AN-311” in this application. Said input port 67 is coupled to the input port 77 of said logarithm amplifier 76. Said input port 67 is also coupled to one port of a resistor 78. The other port of said resistor 78 is coupled to the negative input port of a first operational amplifier 79. The output port 80 of said logarithm amplifier 76 is coupled to one port of a resistor 81. The other port of said resistor 81 is coupled to the negative input port of a second operational amplifier 82. The positive input port of said operational amplifier 79 is grounded. Said negative input port of said operational amplifier 79 is coupled to one port of a resistor 83. The other port of resistor 83 is coupled to the output port of said operational amplifier 79. Said output port of said operational amplifier 79 is coupled to a port of a resistor 84. The other port of said resistor 84 is coupled to said negative input port of said second operational amplifier 82. Said negative input port of said operational amplifier 82 is coupled to one port of a resistor 85. The other port of said resistor 85 is coupled to the output port of said second operational amplifier 82. The positive input port of said operational amplifier 82 is grounded. The output port of said second operational amplifier 82 is coupled to said output port 68.

Said logarithm amplifier 76 has the transfer function of negated logarithm with base 10. The output signal of said logarithm amplifier 76 is scaled and negated and added to the scaled input signal fed into said input port 67. Thus, when said input signal is small, the output signal of said circuit is mostly contributed by said logarithm amplifier 76, so the absolute value of the rate of change of said output signal of said circuit is large. When said input signal is large, the output signal of said circuit is mostly contributed by said first operational amplifier 79, so that the absolute value of the rate of change of said output signal of said circuit is moderate. Thus said circuit acts as a type 1 expander.

### Type 1 Compressor

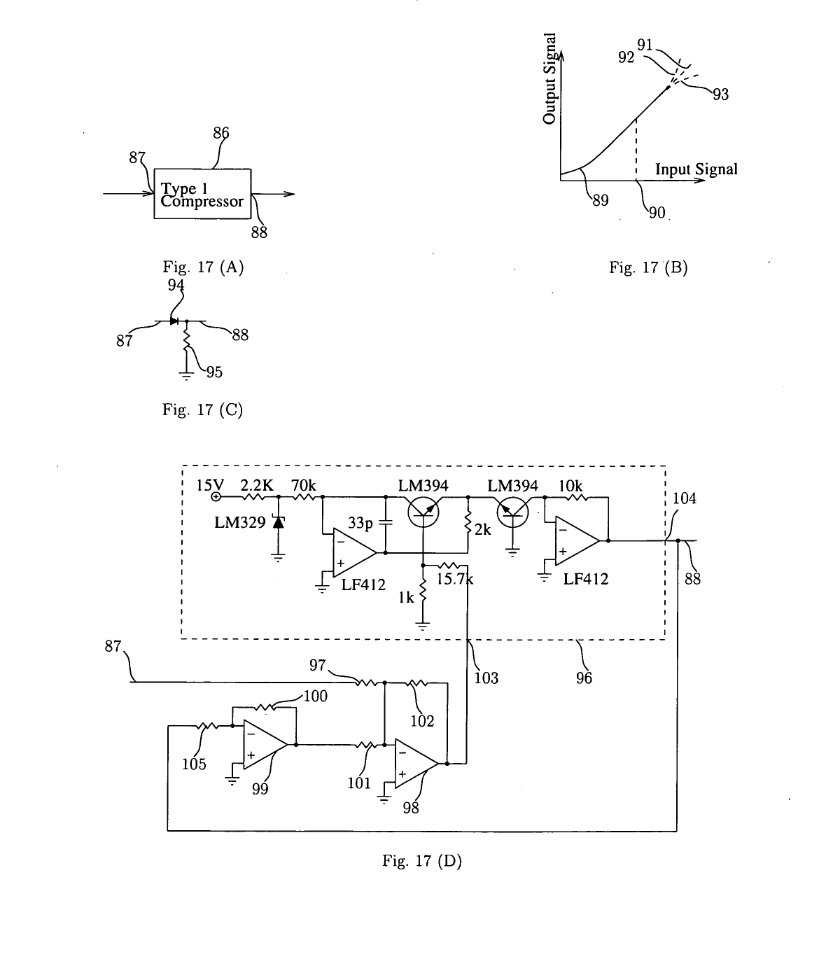

FIG. 17 (A) illustrates a type 1 compressor 86. Said type 1 compressor 86 has at least one input port 87 and one output port 88. The relationship between the output signal taken from said output port 88 and the input signal fed into said input port 87 is that, at least on one extreme of the operation range of said type 1 compressor, when said input signal changes away from the operation point of said type 1 compressor, the absolute value of the rate of change of said output signal monotonously decreases. It is not required that it strictly decreases. FIG. 17 (B) illustrates an example of the relationship between said output signal and said input signal, depicted as a function curve. Denote it type 1 compressor curve. In FIG. 17 (B), 89 is near said extreme of the operation range, which shows that when said input signal decreases from the operation point 90, the absolute value of the rate of change of said output signal monotonously decreases (the slop of the function curve becomes less steep). It does not matter how the function curve looks like at the opposite extreme. It can look like, for example, 91,92,93, or other shapes. It is not required that a substantial portion of the function curve near operation point is linear. The function curve is preferably smooth. It is noted that if said input signal or said output signal or both, of the function curve, are added with fixed values, are negated, or are manipulated with the combination of the two, the resulted new function curves are still type 1 compressor curves, and the type 1 compressor is still a type 1 compressor.

FIG. 17 (C) illustrates an example circuit of said type 1 compressor. The input voltage signal is fed into the input port 87 of the circuit. The output port 88 of said circuit produces output voltage signal. Said input port 87 is coupled to the positive port of a diode 94. The negative port of said diode 94 is coupled to one port of a resistor 95. The other port of said resistor 95 is grounded. Said negative port of said diode 94 is coupled to the output port 88. When the input voltage signal is large, said diode 94 is almost fully conductive, so the output voltage signal is essentially the input voltage signal minus the voltage drop of said diode (usually 0.6V for silicon diodes). When the input voltage signal decreases, the absolute value of the rate of change of said output signal decreases. Thus this circuit acts as a type 1 compressor.

FIG. 17 (D) illustrates another example circuit of said type 1 compressor. The input signal is fed into the input port 87. The output signal is taken from the output port 88. An exponential amplifier 96 is taken from FIG. 2 of said document AN-311. Said input port 87 is coupled to one port of a resistor 97. The other port of said resistor 97 is coupled to the negative input port of a second operational amplifier 98. The negative input port of a first operational amplifier 99 is coupled to one port of a resistor 100. The other port of said resistor 100 is coupled to the output port of said first operational amplifier 99. The positive input port of said first operational amplifier 99 is grounded. Said output port of said first operational amplifier 99 is coupled to a port of a resistor 101. The other port of said resistor 101 is coupled to said negative input port of said second operational amplifier 98. Said negative input port of said second operational amplifier 98 is coupled to one port of a resistor 102. The other port of said resistor 102 is coupled to the output port of said second operational amplifier 98. The positive input port of said operational amplifier 98 is grounded. Said output port of said second operational amplifier 98 is coupled to the input port 103 of said exponential amplifier 96. The output port 104 of said exponential amplifier 96 is coupled to said output port 88 of said example circuit. Said output port 88 is also coupled to one port of a resistor 105. The other port of said resistor 105 is coupled to said negative input port of said first operational amplifier 99.

Said exponential amplifier 96 has the transfer function of negated exponential with base 10. The output signal of said exponential amplifier 96 is scaled and added to the negated and scaled input signal taken from said input port 87, and the result is fed into said exponential amplifier 96. Thus this circuit acts like a reverse of the expander example shown in FIG. 16. The method of such reversing is described in my paper “Loop Reversal Rule in Block Diagram and Signal Flow Graph Manipulation”, IEEE Signal Processing Letters, Volume 19, Issue 10, 2012, 672-675. It is referred as “my SPL paper” in this application. Thus this circuit acts as a type 1 compressor.

### Type 2 Compressor

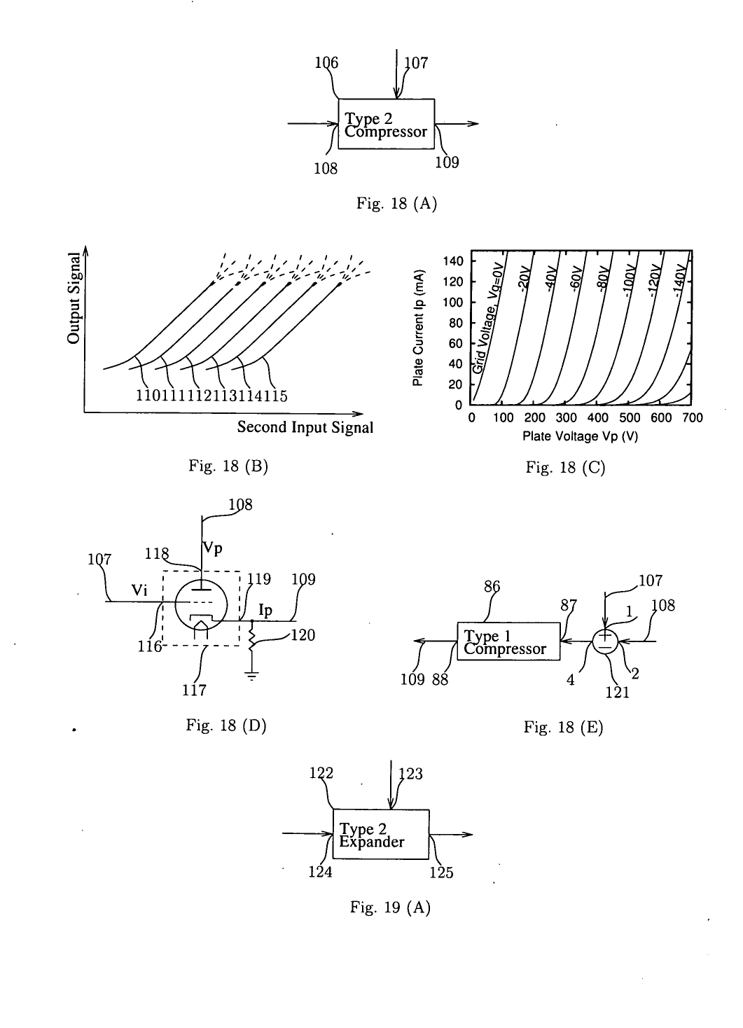

FIG. 18 (A) illustrates a type 2 compressor 106. Type 2 compressor 106 has at least a first input port 107, a second input port 108 and an output port 109. It takes at least a first input signal fed to said first input port 107, a second input signal fed to said second input port 108, and produces at least an output signal to said output port 109, according to the following specification.

FIG. 18 (B) illustrates the said specification. When said first input signal is fixed, the relationship between said output signal and said second input signal follow said type 1 compressor curve (call it the “first curve” in this paragraph only). When said first input signal is changed slightly, the relationship between said output signal and said second input signal still follows a type 1 compressor curve, which is substantially similar to said first curve, and is substantially parallel to said first curve, whose position is shifted to the left or right direction of said first curve, and the change of position from said first curve is substantially proportional to the change of said first input signal. In FIG. 18, curves 110, 111, 112, 113, 114, and 115 represent type 1 compressor curves corresponding to different first input signals.

FIG. 18 (C) illustrates the output characteristic of a typical triode, the 300B triode. When Vg, Vp and Ip are corresponding to said first input signal, said second input signal, and said output signal, a triode is an example of type 2 compressor according to said specification. Note that for different Vg's, the Ip vs Vp curves are similar but not identical.

FIG. 18 (D) illustrates an example of the type 2 compressor specified by said specification. It is related to FIG. 18 (C). The first input signal 107 is coupled to port 116 of said triode or triode emulator 117. The second input port 108 is coupled to port 118 of triode or triode emulator 117. The output port 109 is coupled to port 119 of said triode or triode emulator 117. The output port 119 of triode or triode emulator 117 is also coupled to one port of a resistor 120. The other port of said resistor 120 is grounded. When the value of said resistor 120 is small, it does not affect the characteristic of the triode or triode emulator much but is still capable of extracting the Ip signal.

FIG. 18 (E) illustrate another example of the type 2 compressor. The first input port 107 is coupled to the first input port 1 of a proportional adder/subtracter 121. The second input port 108 is coupled to the second input port of said proportional adder/subtracter 121. The output port 4 of said proportional adder/subtracter 121 is coupled to the input port 87 of a type 1 compressor 86. The output port 88 of said compressor 86 is coupled to the output port 109.

### Type 2 Expander

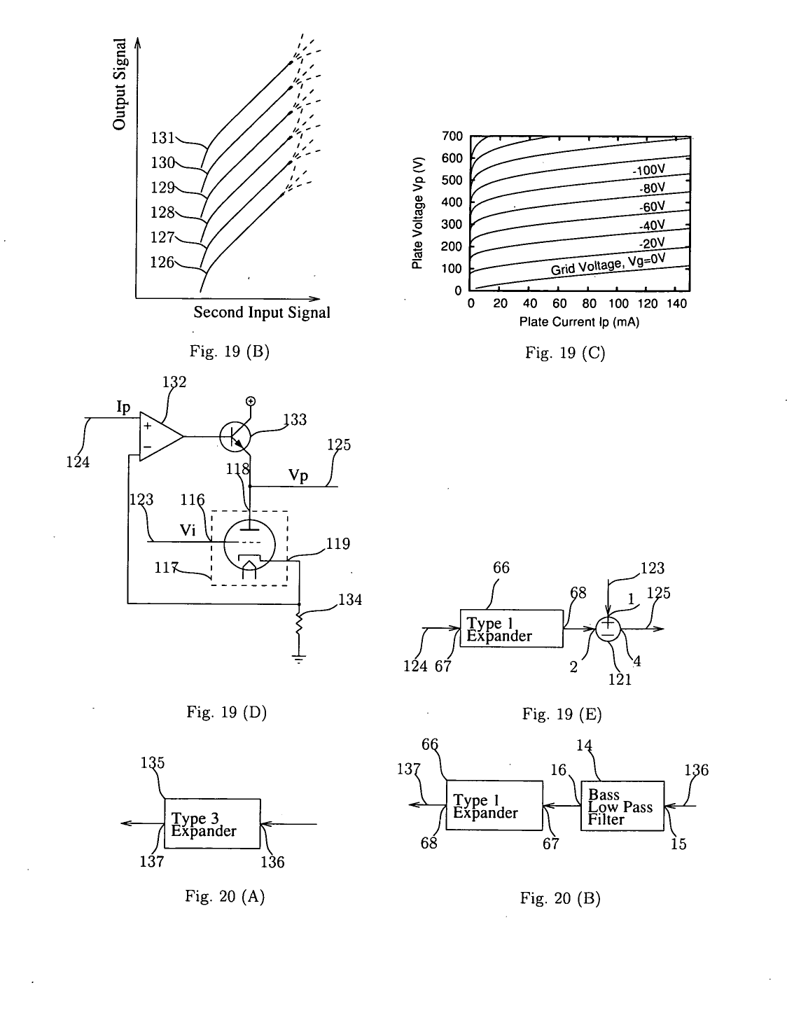

FIG. 19 (A) illustrates a type 2 expander 122. Type 2 expander 122 has at least a first input port 123, a second input port 124 and an output port 125. It takes at least a first input signal fed to said first input port 123, a second input signal fed to said second input port 124, and produces at least an output signal to said output port 125, according to the following specification.

FIG. 19 (B) illustrates the specification. When said first signal is fixed, the relationship between output signal and said second input signal follow said type 1 expander curve (call it the “first curve” in this paragraph only). When said first input signal is changed slightly, the relationship between output signal and said second input signal still follow a type 1 expander curve, which is similar to the said first curve, and is substantially parallel to said first curve, whose position is changed to the up or down direction of said first curve, the change of position from said first curve is substantially proportional to the change of said first input signal. In FIG. 19 (B), curves 126, 127, 128, 129, 130, and 131 represent type 1 expander curves corresponding to different first input signal.

FIG. 19 (C) illustrate the Ip, Vp and Vg curve of atypical triode, the 300B triode. When Vg, Ip and Vp are corresponding to said first input signal, said second input signal, and said output signal, said typical triode is an example of type 2 expander according to said specification of type 2 expander. Note that for different Vg's, the Vp vs Ip curve are similar but not identical.

FIG. 19 (D) illustrate an example of the type 2 expander specified by said specification. It is related to FIG. 19 (C). The first input port 123 is coupled the first port 116 of a triode or triode emulator 117. The second input port 124 is coupled to the positive input port of an operational amplifier 132. The output port of said operational amplifier 132 is coupled to the base of a NPN transistor 133. The collector of said NPN transistor 133 is connected to a positive power supply. The emittor of said NPN transistor 133 is coupled to the second port 118 of a triode or triode emulator 117. Said second port 118 of a triode or triode emulator 117 is coupled to said output port 125. The third port 119 of said triode or triode emulator 117 is coupled to a port of resistor 134. The third port 119 of said triode or triode emulator 117 is also coupled to the negative input port of said operational amplifier 132. The other port of said resistor 134 is grounded. Said operational amplifier 132 and said NPN transistor 133 forces a current Ip into said second port 118 of said transistor means 117, and the resulted Vp is a function of both Vi and Ip.

FIG. 19 (E) illustrates another example of the type 2 expander. The first input port 123 is coupled to the first input port 1 of a proportional adder/subtracter 121. The second input port 124 is coupled to the input port 67 of a type 1 expander 66. The output port 68 of said type 1 expander 66 is coupled to the second input port of said proportional adder/subtracter 121. The output port 4 of said proportional adder/subtracter 121 is coupled to the output port 125.

### Type 3 Expander

FIG. 20 (A) illustrates a type 3 expander 135. Type 3 compressor 135 has at least an input port 136 and an output port 137.

FIG. 20 (B) illustrates an example of type 3 expander. The input port 136 is coupled to the input port 15 of a bass low pass filter 14. The output port 16 of said bass low pass filter 14 is coupled to the input port 67 of a type 1 expander 66. The output port 68 of said type 1 expander 66 is coupled to the output port 137.

Type 3 expander 135 selectively expands higher frequency components in said low frequency range so that it can be used in the tube amplifier emulator to treat signals with different frequencies and amplitude differently.

### Type 3 Compressor

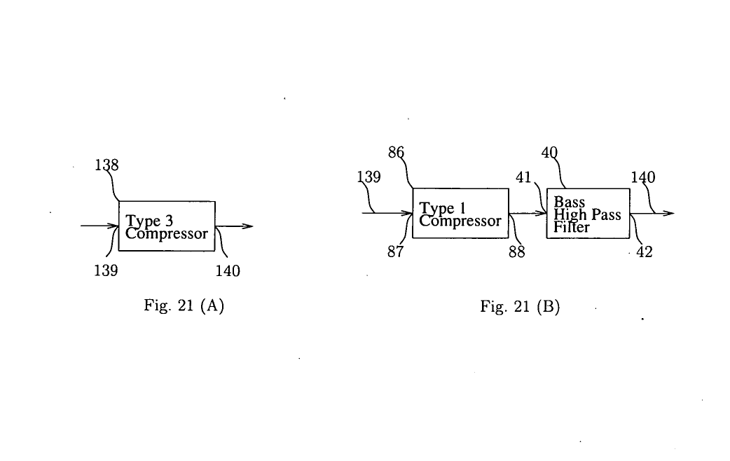

FIG. 21 (A) illustrates a type 3 compressor 138. Type 3 compressor 138 has at least an input port 139 and an output port 140.

FIG. 21 (B) illustrates an example of type 3 compressor. The input port 139 is coupled to the input port 87 of a type 1 compressor 86. The output port 88 of said type 1 compressor 86 is coupled to the input port 41 of a bass high pass filter 40. The output port 42 of said bass high pass filter 40 is coupled to the output port 140.

Type 3 compressor 138 is a reverse of Type 3 expander 135.

### Voltage Driver

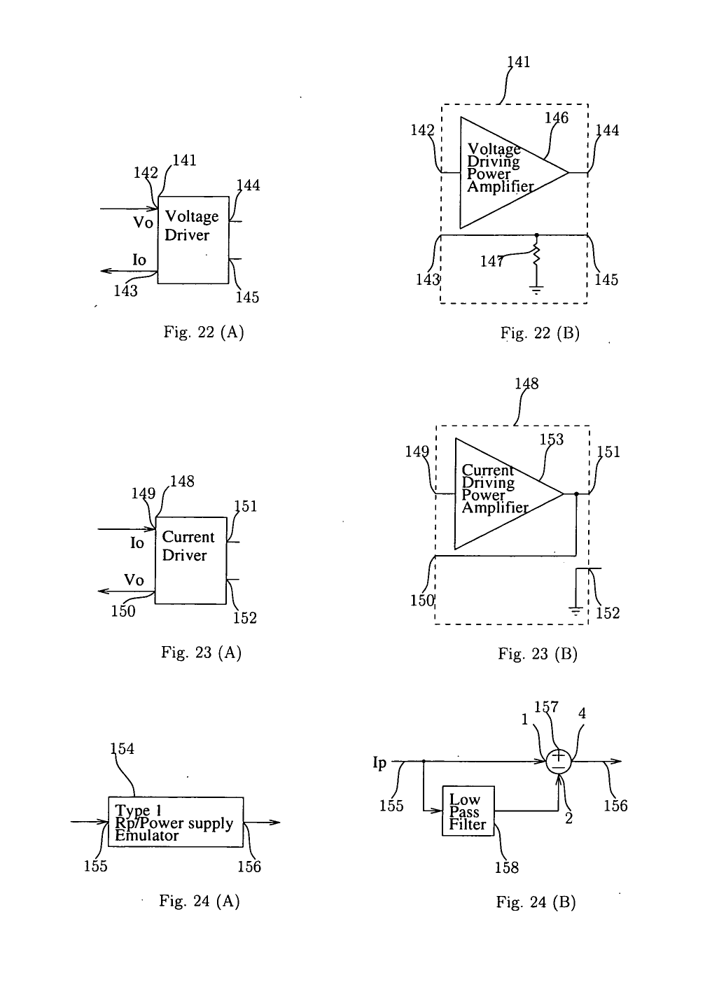

FIG. 22 (A) illustrates the symbol of a voltage driver 141. A voltage driver has at least an input port 142, an output port 143, a first terminal 144 and a second terminal 145. Said voltage driver receives input signal from said input port 142, amplifies or attenuates it, and output a voltage between said first terminal 144 and said second terminal 145 that is substantially proportional to said input signal received from said input port 142. The voltage between said first terminal 144 and said second terminal 145 is capable of driving loudspeakers or earphones. A signal proportional to the output current between said first terminal 144 and second terminal 145 is sent to said output port 143.

FIG. 22 (B) illustrates an example of said voltage driver. It has an input port 142, an output port 143, a first terminal 144 and a second terminal 145. The input port 142 is coupled to the input port of a voltage driving power amplifier 146. The output port of said voltage driving power amplifier is coupled to said output terminal 144. Said output terminal 145 is coupled to said output port 143, and also coupled to one port of a resistor 147. The other port of said resistor 147 is grounded. Thus the output current flows out of said first terminal 141 flows back into said second terminal 145, and further flows through said resistor 147 so the current signal is converted into voltage signal and is sent to said output port 143.

### Current Driver

FIG. 23 (A) illustrates the symbol of a current driver 148. A current driver has at least an input port 149, an output port 150, a first terminal 151 and a second terminal 152. Said current driver receives input signal from said input port 149, amplifies or attenuates it, and output a current between said first terminal 151 and said second terminal 152 that is substantially proportional to said input signal received from said input port 149. The current between said first terminal 151 and said second terminal 152 is capable of driving loudspeakers or earphones. A signal proportional to the output voltage between said first terminal 151 and second terminal 152 is sent to said output port 150.

FIG. 23 (B) illustrates an example of said current driver. It has an input port 149, an output port 150, a first terminal 151 and a second terminal 152. The input port 149 is coupled to the input port of a current driving power amplifier 153. The output port of said current driving power amplifier is coupled to said first output terminal 151. Said first output terminal 151 is coupled to said output port 150. Said second output terminal 152 is grounded. Thus the output voltage between said first terminal 151 and second terminal 152 is sent to said output port 150.

### Type 1 Rp/Power Supply Emulator

FIG. 24 (A) illustrates the symbol of a type 1 Rp/Power supply emulator 154. Rp represents the resistance of primary winding of the output transformer found in a vacuum tube amplifier. A typical power supply found in a vacuum tube amplifier has low pass filter characteristic. According to said my AES paper, the effect of Rp and the power supply can be emulated with the Rp/Power supply emulator. Said type 1 Rp/Power supply emulator 154 has at least one input port 155 and one output port 156. The input signal received from said input port 155 is passed through a low pass filter and the result is sent out to said output port 156.

FIG. 24 (B) illustrates an example of said type 1 Rp/Power supply emulator 154. The input port 155 is coupled to a first input port 1 of a proportional adder/subtracter 157, and is also coupled to the input port of a low pass filter 158 that has a cut off frequency close to one found in a typical vacuum tube amplifier high voltage power supply line (so called “B+”). The low pass filter is preferably first order or second order filter. The output of said low pass filter 158 is coupled to the second input port 2 of said proportional adder/subtracter 157. The output port 4 of said proportional adder/subtracter 157 is coupled to said output port 156.

### Type 2 Rp/Power Supply Emulator

According to said my SPL paper, a loop in a block diagram or a circuit can be reversed and the input output relationship of the block diagram or circuit is not affected. Thus if the Type 1 Rp/Power Supply Emulator is in a loop, it can be reversed to allow the loop to be reversed. The reversing of Type 1 Rp/Power Supply Emulator results in Type 2 Rp/Power Supply Emulator.

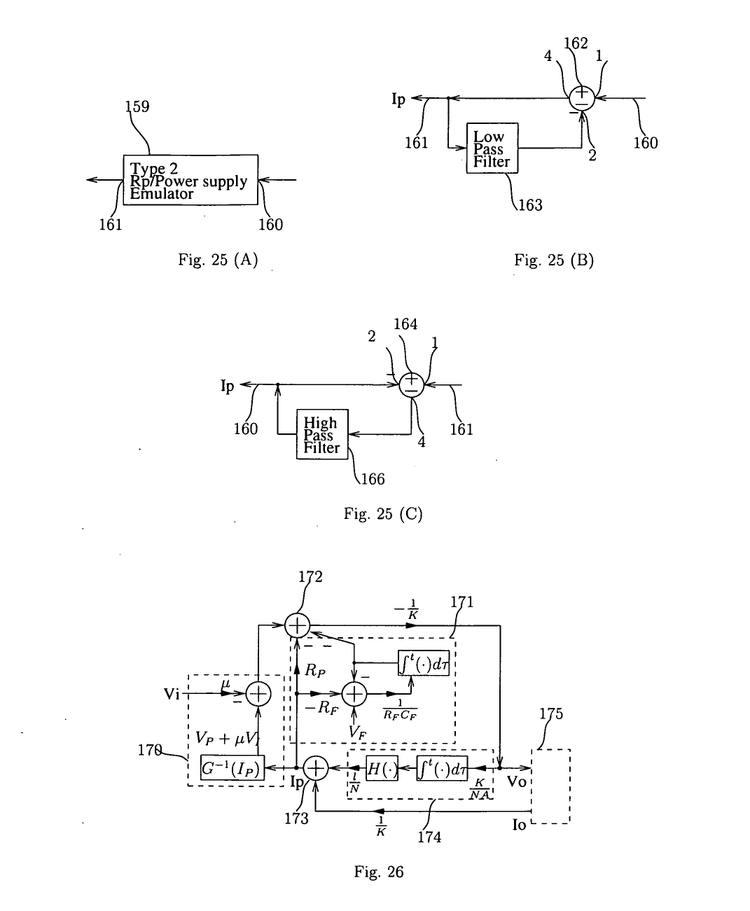

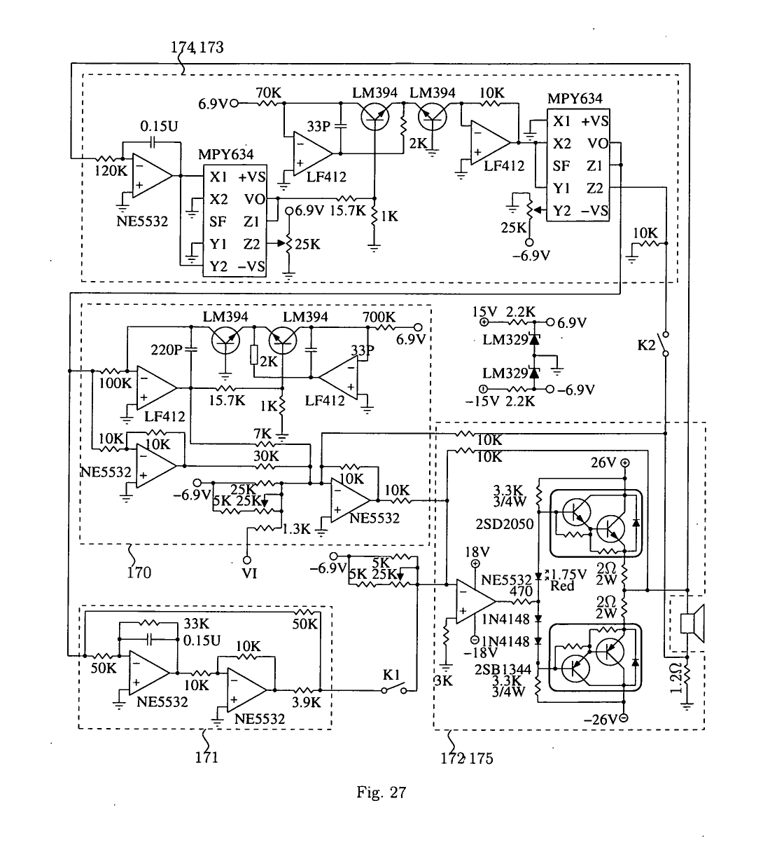

FIG. 25 (A) illustrates the symbol of type 2 Rp/Power supply emulator 159. Type 2 Rp/Power supply emulator 159 has at least one input port 160 and one output port 161. The input signal received from said input port 160 is passed through a circuit with high pass filter characteristic and the result is sent out to said output port 161.

FIG. 25 (B) illustrates an example of type 2 Rp/Power supply emulator 159. The input port 160 is coupled to the first input port 1 of a proportional adder/subtracter 162. The output port 4 of said proportional adder/subtracter 162 is coupled to the output port 161, and is also coupled to the input port of a low pass filter 163. The output of said low pass filter 163 is coupled to the second input port of said proportional adder/subtracter 162. This method of reversing is described in detail in said my SPL paoer.

FIG. 25 (C) illustrates another example of type 2 Rp/Power supply emulator 159. The input port 160 is coupled to the first input port 1 of a proportional adder/subtracter 164.

The output port 165 of said proportional adder/subtracter 164 is coupled to the input port of a high pass filter 166. The output port of said high pass filter 166 is coupled to the output port 161, and is also coupled to the second input port 2 of said proportional adder/subtracter 164. The high pass filter is preferably first order or second order filter with a cut off frequency close to one found in a typical vacuum tube amplifier high voltage power supply line (so called “B+”).

Embodiments of the Tube amplifier Emulator

FIG. 26 illustrates one configuration of the invented methods and apparatus of tube amplifier emulator that was disclosed in said my AES paper.

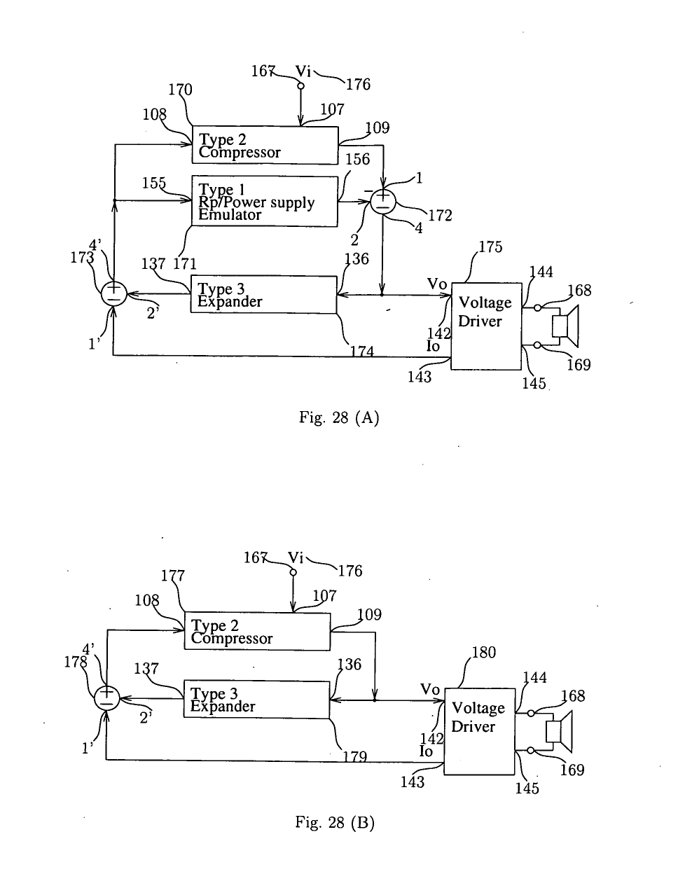

The first preferred embodiment is illustrated in FIG. 28(A-B), which is a redraw of FIG. 26. According to FIG. 28(A), Said tube amplifier emulator configuration has at least one input port 167, one first output terminal 168, one second output terminal 169, one type 2 compressor 170, one type 1 Rp/power supply emulator 171, one first proportional adder/subtracter 172, one second proportional adder/subtracter 173, one type 3 expander 174, and one voltage driver 175. The input signal 176 is coupled to said input port 167, which is coupled to the first input port 107 of said type 2 compressor 170. The output port 109 of said type 2 compressor 170 is coupled to the first input port 1 of said first proportional adder/subtracter 172. The output port 4 of said first proportional adder/subtracter 172 is coupled to the input port 142 of said voltage driver 175. The input port 136 of said type 3 expander 174 is coupled to the output port 4 of said first proportional adder/subtracter 172. The output port 137 of said type 3 expander 174 is coupled to the second input port 2′ of said second proportional adder/subtracter 173. The output port 143 of said voltage driver 175 is coupled to the first input port 1′ of said second proportional adder/subtracter 173. The output port 4′ of said second proportional adder/subtracter 173 is coupled to both the input port 155 of said type 1 Rp/power supply emulator 171 and the input port 108 of said type 2 compressor 170. The output port 156 of said type 1 Rp/power supply emulator 171 is coupled to the second input port 2 of said first proportional adder/subtracter 172. Said output terminal 168 is coupled to the first output terminal 144 of said voltage driver 175. Said output terminal 169 is coupled to the second terminal 145 of said voltage driver 175. The output terminals 168 and 169 are coupled to a loudspeaker or loudspeakers.

In FIG. 28 (B) the optional type 1 Rp/power supply emulator is removed. According to FIG. 28(B), the Rp/power supply emulator and corresponding proportional adder/subtracter are removed, compared to FIG. 28. Said tube amplifier emulator configuration has at least one input port 167, one first output terminal 168, one second output terminal 169, one type 2 compressor 177, one proportional adder/subtracter 178, one type 3 expander 179, and one voltage driver 180. The input signal 176 is coupled to said input port 167, which is coupled to the first input port 107 of said type 2 compressor 177. The output port 109 of said type 2 compressor 177 is coupled to the input port 142 of said voltage driver 180. The input port 136 of said type 3 expander 179 is coupled to the output port 109 of said type 2 compressor 177. The output port 137 of said type 3 expander 179 is coupled to the second input port 2′ of said proportional adder/subtracter 178. The output port 143 of said voltage driver 180 is coupled to the first input port 1′ of said proportional adder/subtracter 178. The output port 4′ of said proportional adder/subtracter 178 is coupled to the input port 108 of said type 2 compressor 177. Said output terminal 168 is coupled to the first output terminal 144 of said voltage driver 180. Said output terminal 169 is coupled to the second terminal 145 of said voltage driver 180. The output terminals 168 and 169 are coupled to a loudspeaker or loudspeakers.

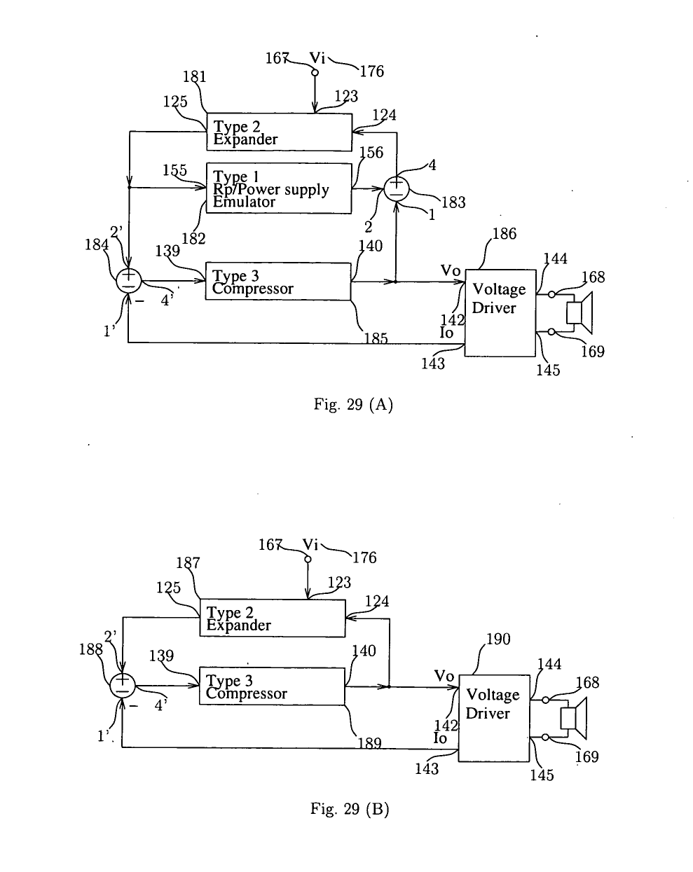

FIG. 29 (A-B) illustrate another preferred embodiment of the present invention. In this configuration a loop is reversed, compared to FIG. 28. Said tube amplifier emulator configuration has at least one input port 167, one first output terminal 168, one second output terminal 169, one type 2 expander 181, one type 1 Rp/power supply emulator 182, one first proportional adder/subtracter 183, one second proportional adder/subtracter 184, one type 3 compressor 185, and one voltage driver 186. The input signal 176 is coupled to said input port 167, which is coupled to the first input port 123 of said type 2 expander 181. The second input port 124 of said type 2 expander 181 is coupled to the output port 4 of said first proportional adder/subtracter 183. The first input port 1 of said first proportional adder/subtracter 183 is coupled to the output port 140 of the type 3 compressor 185. The output port 140 of said type 3 compressor 185 is coupled to the input port 142 of said voltage driver 186. The input port 139 of said type 3 compressor 185 is coupled to the output port 4′ of said second proportional adder/subtracter 184. The output port 143 of said voltage driver 186 is coupled to the first input port 1′ of said second proportional adder/subtracter 184. The second input port 2′ of said second proportional adder/subtracter 184 is coupled to the output port 125 of said type 2 expander 181. The input port 155 of said type 1 Rp/power supply emulator 182 is coupled to the output port 125 of said type 2 expander 181. The output port 156 of said type 1 Rp/power supply emulator 182 is coupled to the second input port 2 of said first proportional adder/subtracter 183. Said output terminal 168 is coupled to the first output terminal 144 of said voltage driver 186. Said output terminal 169 is coupled to the second terminal 145 of said voltage driver 186. The output terminals 168 and 169 are coupled to a loudspeaker or loudspeakers.

In FIG. 29 (B) the optional type 1 Rp/power supply emulator is removed. According to FIG. 29(B), the Rp/power supply emulator and corresponding proportional adder/subtracter are removed, compared to FIG. 29(A). Said tube amplifier emulator configuration has at least one input port 167, one first output terminal 168, one second output terminal 169, one type 2 expander 187, one proportional adder/subtracter 188, one type 3 compressor 189, and one voltage driver 190. The input signal 176 is coupled to said input port 167, which is coupled to the first input port 123 of said type 2 expander 187. The second input port 124 of said type 2 expander 187 is coupled to the output port 140 of the type 3 compressor 189. The output port 140 of said type 3 compressor 189 is coupled to the input port 142 of said voltage driver 190. The input port 139 of said type 3 compressor 189 is coupled to the output port 4′ of said proportional adder/subtracter 188. The output port 143 of said voltage driver 190 is coupled to the first input port 1′ of said proportional adder/subtracter 188. The second input port 2′ of said proportional adder/subtracter 188 is coupled to the output port 125 of said type 2 expander 187. Said output terminal 168 is coupled to the first output terminal 144 of said voltage driver 190. Said output terminal 169 is coupled to the second terminal 145 of said voltage driver 190. The output terminals 168 and 169 are coupled to a loudspeaker or loudspeakers.

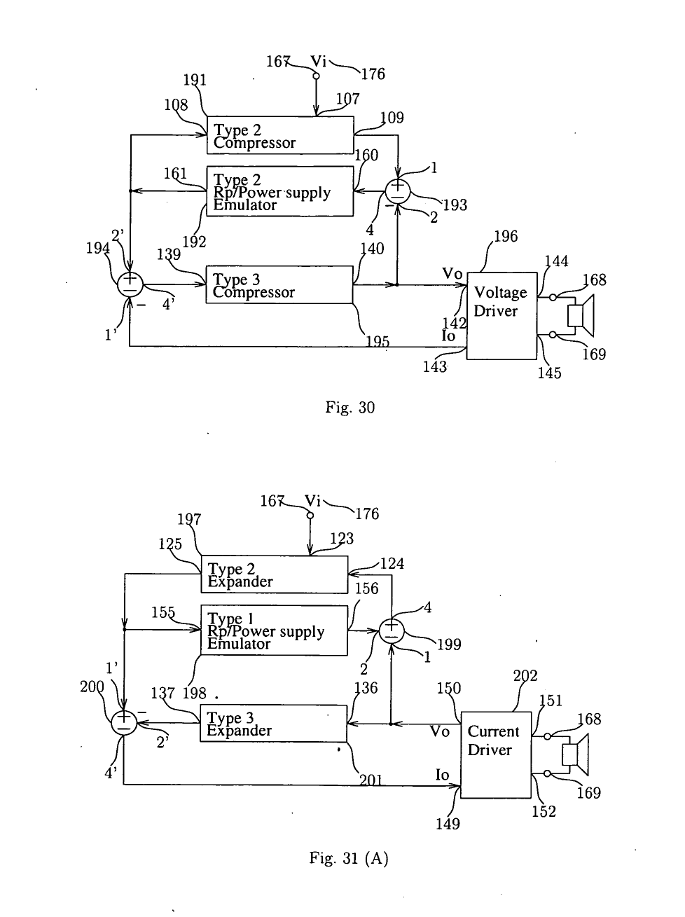

FIG. 30 illustrate another preferred embodiment of the present invention. According to FIG. 30, a loop is reversed, compared to FIG. 28(A). Said tube amplifier emulator configuration has at least one input port 167, one first output terminal 168, one second output terminal 169, one type 2 compressor 191, one type 2 Rp/power supply emulator 192, one first proportional adder/subtracter 193, one second proportional adder/subtracter 194, one type 3 compressor 195, and one voltage driver 196. The input signal 176 is coupled to said input port 167, which is coupled to the first input port 107 of said type 2 compressor 191. The output port 109 of said type 2 compressor 191 is coupled to the first input port 1 of said first proportional adder/subtracter 193. The second input port 2 of said first proportional adder/subtracter 193 is coupled to the output port 140 of the type 3 compressor 195. The output port 140 of said type 3 compressor 195 is coupled to the input port 142 of said voltage driver 196. The input port 139 of said type 3 compressor 195 is coupled to the output port 4′ of said second proportional adder/subtracter 194. The output port 143 of said voltage driver 196 is coupled to the first input port 1′ of said second proportional adder/subtracter 194. The output port 161 of said type 2 Rp/power supply emulator 192 is coupled both to the second input port 2′ of said second proportional adder/subtracter 194 and to the input port 108 of said type 2 compressor 191. The input port 160 of said type 2 Rp/power supply emulator 192 is coupled to the output port 4 of said first proportional adder/subtracter 193. Said output terminal 168 is coupled to the first output terminal 144 of said voltage driver 196. Said output terminal 169 is coupled to the second terminal 145 of said voltage driver 196. The output terminals 168 and 169 are coupled to a loudspeaker or loudspeakers.

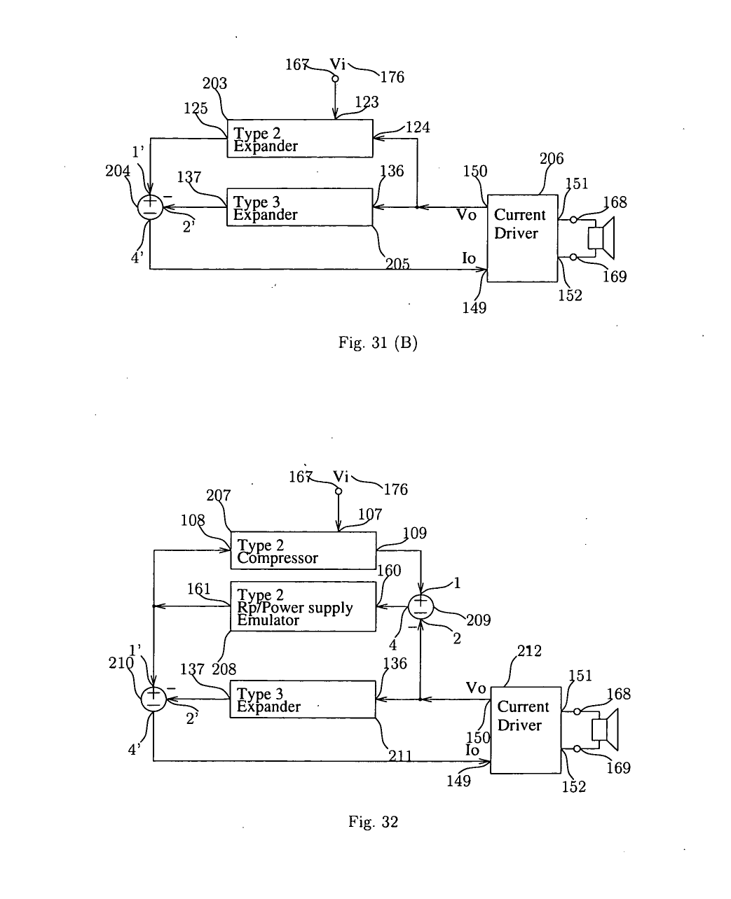

FIG. 31(A-B) illustrate another preferred embodiment of the present invention. According to FIG. 31 (A), a loop is reversed, compared to FIG. 28(A). Said tube amplifier emulator configuration has at least one input port 167, one first output terminal 168, one second output terminal 169, one type 2 expander 197, one type 1 Rp/power supply emulator 198, one first proportional adder/subtracter 199, one second proportional adder/subtracter 200, one type 3 expander 201, and one current driver 202. The input signal 176 is coupled to said input port 167, which is coupled to the first input port 123 of said type 2 expander 197. The input port 124 of said type 2 expander 197 is coupled to the output port 4 of said first proportional adder/subtracter 199. The input port 1 of said first proportional adder/subtracter 199 is coupled to the output port 150 of said current driver 202. The input port 136 of said type 3 expander 201 is coupled to the output port 150 of said current driver 202. The output port 137 of said type 3 expander 201 is coupled to the second input port 2′ of said second proportional adder/subtracter 200. The input port 149 of said current driver 202 is coupled to the output port 4′ of said second proportional adder/subtracter 200. The first input port 1′ of said second proportional adder/subtracter 200 is coupled to the output port 125 of said type 2 expander 197. The input port 155 of said type 1 Rp/power supply emulator 198 is coupled to said output port 125 of said type 2 expander 197. The output port 156 of said type 1 Rp/power supply emulator 198 is coupled to the second input port 2 of said first proportional adder/subtracter 199. Said output terminal 168 is coupled to the first output terminal 151 of said current driver 202. Said output terminal 169 is coupled to the second terminal 152 of said current driver 202. The output terminals 168 and 169 are coupled to a loudspeaker or loudspeakers.

In FIG. 31(B), the optional type 1 Rp/power supply emulator is removed. According to FIG. 31 (B), the Rp/power supply emulator and corresponding proportional adder/subtracter are removed, compared to FIG. 31(A). Said tube amplifier emulator configuration has at least one input port 167, one first output terminal 168, one second output terminal 169, one type 2 expander 203, one proportional adder/subtracter 204, one type 3 expander 205, and one current driver 206. The input signal 176 is coupled to said input port 167, which is coupled to the first input port 123 of said type 2 expander 203. The input port 124 of said type 2 expander 203 is coupled to the output port 150 of said current driver 206. The input port 136 of said type 3 expander 205 is coupled to the output port 150 of said current driver 206. The output port 137 of said type 3 expander 205 is coupled to the second input port 2′ of said second proportional adder/subtracter 204. The input port 149 of said current driver 206 is coupled to the output port 4′ of said proportional adder/subtracter 204. The first input port 1′ of said proportional adder/subtracter 204 is coupled to the output port 125 of said type 2 expander 203. Said output terminal 168 is coupled to the first output terminal 151 of said current driver 206. Said output terminal 169 is coupled to the second terminal 152 of said current driver 206. The output terminals 168 and 169 are coupled to a loudspeaker or loudspeakers.

FIG. 32 illustrate another preferred embodiment of the present invention. According to FIG. 32, a loop is reversed, compared to FIG. 28(A). Said tube amplifier emulator configuration has at least one input port 167, one first output terminal 168, one second output terminal 169, one type 2 compressor 207, one type 2 Rp/power supply emulator 208, one first proportional adder/subtracter 209, one second proportional adder/subtracter 210, one type 3 expander 211, and one current driver 212. The input signal 176 is coupled to said input port 167, which is coupled to the first input port 107 of said type 2 compressor 207. The output port 109 of said type 2 compressor 207 is coupled to the first input port 1 of said first proportional adder/subtracter 209. The second input port 2 of said first proportional adder/subtracter 209 is coupled to the output port 150 of said current driver 212. The input port 136 of said type 3 expander 211 is coupled to the output port 150 of said current driver 212. The output port 137 of said type 3 expander 211 is coupled to the second input port 2′ of said second proportional adder/subtracter 210. The input port 149 of said current driver 212 is coupled to the output port 4′ of said second proportional adder/subtracter 210. The first input port 1′ of said second proportional adder/subtracter 210 is coupled to the output port 161 of said type 2 Rp/power supply emulator 208. The input port 108 of said type 2 compressor 207 is coupled to said output port 161 of said type 2 Rp/power supply emulator 208. The input port 160 of said type 2 Rp/power supply emulator 208 is coupled to the output port 4 of said first proportional adder/subtracter 209. Said output terminal 168 is coupled to the first output terminal 151 of said current driver 212. Said output terminal 169 is coupled to the second terminal 152 of said current driver 212. The output terminals 168 and 169 are coupled to a loudspeaker or loudspeakers.

I claim:

1. A speaker driving circuit without output transformer for nonlinearly modifying bass frequency components of input signal according to the amplitudes of those bass frequency components included in said input signal, while leaving higher frequency components included in said input signal approximately unaffected by said nonlinear modifying, comprising:
a type 2 compressor,
a type 3 expander,
a voltage driver,
a second proportional adder/subtracter,
an optional first proportional adder/subtracter,
an optional type 1 Rp/Power supply emulator,
where the first input port of said type 2 compressor receives said input signal, the first output terminal and the second output terminal of said voltage driver coupled to a loudspeaker or a plural of loudspeakers, the output port of said voltage driver coupled to the first input port of said second proportional adder/subtracter, the output port of said type 3 expander is coupled to the second input port of said second proportional adder/subtracter, the output port of said second proportional adder/subtracter is coupled to the second input port of said type 2 compressor, and either:
said output port of said second proportional adder/subtracter is coupled to the input port of said optional type 1 Rp/Power supply emulator, the output port of said optional type 1 Rp/Power supply emulator is coupled to the second input port of said optional first proportional adder/subtracter, the output port of said type 2 compressor is coupled to the first input port of said optional first proportional adder/subtracter, the output port of said optional first proportional adder/subtracter is coupled to the input port of said type 3 expander, and is also coupled to the input port of said voltage driver, or:
the output port of said type 2 compressor is coupled to the input port of said type 3 expander, and is also coupled to the input port of said voltage driver, whereby said speaker driving circuit can be used to emulate vacuum tube amplifiers, to achieve sound effects, or to protect speakers from damaging from excessive cone excursion, or any combination of them.

2. A circuit according to claim 1, where said type 2 compressor comprises a triode or triode emulator.

3. A circuit according to claim 1, where said type 2 compressor comprises a type 1 compressor and a proportional adder/subtracter.

4. A circuit according to claim 1, where said type 3 expander comprises a type 1 expander and a bass low pass filter.

5. A speaker driving circuit without output transformer for nonlinearly modifying bass frequency components of input signal according to the amplitudes of those bass frequency components included in said input signal, while leaving higher frequency components included in said input signal approximately unaffected by said nonlinear modifying, comprising:
a type 2 expander,
a type 3 compressor,
a voltage driver,
a second proportional adder/subtracter,
an optional first proportional adder/subtracter,
an optional type 1 Rp/Power supply emulator,
where the first input port of said type 2 expander receives said input signal, the first output terminal and the second output terminal of said voltage driver coupled to a loudspeaker or a plural of loudspeakers, the output port of said voltage driver coupled to the first input port of said second proportional adder/subtracter, the output port of said type 3 compressor is coupled to the input port of said voltage driver, the output port of said type 2 expander is coupled to the second input port of said second proportional adder/subtracter, the output port of said second proportional adder/subtracter is coupled to the input port of said type 3 compressor, and either:
the output port of said type 2 expander is coupled to the input port of said optional type 1 Rp/Power supply emulator, the output port of said type 3 compressor is coupled to the first input port of said optional first proportional adder/subtracter, the output port of said optional type 1 Rp/Power supply emulator is coupled to the second input port of said optional first proportional adder/subtracter, the output port of said optional first proportional adder/subtracter is coupled to the input port of said type 2 expander, or:
the output port of said type 3 compressor is coupled to the input port of type 2 expander, whereby said speaker driving circuit can be used to emulate vacuum tube amplifiers, to achieve sound effects, or to protect speakers from damaging from excessive cone excursion, or any combination of them.

6. A circuit according to claim 5, where said type 2 expander comprises a triode or triode emulator.

7. A circuit according to claim 5, where said type 2 expander comprises a type 1 expander and a proportional adder/subtracter.

8. A circuit according to claim 5, where said type 3 compressor comprises a type 1 compressor and a bass high pass filter.

9. A speaker driving circuit without output transformer for nonlinearly modifying bass frequency components of input signal according to the amplitudes of those bass frequency components included in said input signal, while leaving higher frequency components included in said input signal approximately unaffected by said nonlinear modifying, comprising:
a type 2 compressor,
a type 3 compressor,
a voltage driver,
a second proportional adder/subtracter,
a first proportional adder/subtracter,
a type 2 Rp/Power supply emulator,
where the first input port of said type 2 compressor receives said input signal, the first output terminal and the second output terminal of said voltage driver coupled to a loudspeaker or a plural of loudspeakers, the output port of said voltage driver coupled to the first input port of said second proportional adder/subtracter, the output port of said type 3 compressor is coupled to the input port of said voltage driver, and is also coupled to the second input port of said first proportional adder/subtracter, the output port of said type 2 compressor is coupled to the first input port of said first proportional adder/subtracter, the output port of said first proportional adder/subtracter is coupled to the input port of said type 2 Rp/Power supply emulator, the output port of said type 2 Rp/Power supply emulator is coupled to the second input port of said second proportional adder/subtracter, and is also coupled to the input port of said type 2 compressor, whereby said speaker driving circuit can be used to emulate vacuum tube amplifiers, to achieve sound effects, or to protect speakers from damaging from excessive cone excursion, or any combination of them.

10. A circuit according to claim 9, where said type 2 compressor comprises a triode or triode emulator.

11. A circuit according to claim 9, where said type 2 compressor comprises a type 1 compressor and a proportional adder/subtracter.

12. A circuit according to claim 9, where said type 3 compressor comprises a type 1 compressor and a bass high pass filter.

13. A speaker driving circuit without output transformer for nonlinearly modifying bass frequency components of input signal according to the amplitudes of those bass frequency components included in said input signal, while leaving higher frequency components included in said input signal approximately unaffected by said nonlinear modifying, comprising:
a type 2 expander,
a type 3 expander,
a current driver,
a second proportional adder/subtracter,
an optional first proportional adder/subtracter,
an optional type 1 Rp/Power supply emulator,
where the first input port of said type 2 expander receives said input signal, the output port of said type 2 expander is coupled to the first input port of said second proportional adder/subtracter, the output port of said type 3 expander is coupled to the second input port of said second proportional adder/subtracter, the output port of said second input port of said second proportional adder/subtracter is coupled to the input port of said current driver, the first output terminal and the second output terminal of said current driver coupled to a loudspeaker or a plural of loudspeakers, the output port of said current driver is coupled to the input port of said type 3 expander, and either:
the output port of said second proportional adder/subtracter is coupled to the input port of said optional type 1 Rp/Power supply emulator, the output port of said optional type 1 Rp/Power supply emulator is coupled to the second input port of said optional first proportional adder/subtracter, said output port of said current driver is coupled to the first input port of said optional first proportional adder/subtracter, the output port of said optional first proportional adder/subtracter is coupled to the input port of said type 2 expander, or: said output port of said current driver is coupled to the input port of said type 2 expander, whereby said speaker driving circuit can be used to emulate vacuum tube amplifiers, to achieve sound effects, or to protect speakers from damaging from excessive cone excursion, or any combination of them.

14. A circuit according to claim 13, where said type 2 expander comprises a triode or triode emulator.

15. A circuit according to claim 13, where said type 2 expander comprises a type 1 expander and a proportional adder/subtracter.

16. A circuit according to claim 13, where said type 3 expander comprises a type 1 expander and a bass low pass filter.

17. A speaker driving circuit without output transformer for nonlinearly modifying bass frequency components of input signal according to the amplitudes of those bass frequency components included in said input signal, while leaving higher frequency components included in said input signal approximately unaffected by said nonlinear modifying, comprising:
a type 2 compressor,
a type 3 expander,
a current driver,
a second proportional adder/subtracter,
a first proportional adder/subtracter,
a type 2 Rp/Power supply emulator,
where the first input port of said type 2 compressor receives said input signal, the first output terminal and the second output terminal of said current driver coupled to a loudspeaker or a plural of loudspeakers, the output port of said current driver is coupled to the input port of said type 3 expander, and is also coupled to the second input port of said first proportional adder/subtracter, the output port of said type 3 expander is coupled to the second input port of said second proportional adder/subtracter, the output port of said second input port of said second proportional adder/subtracter is coupled to the input port of said current driver, the output port of said type 2 compressor is coupled to the first input port of said first proportional adder/subtracter, the output port of said first proportional adder/subtracter is coupled to the input port of said type 2 Rp/Power supply emulator, the output port of said type 2 Rp/Power supply emulator is coupled to the first input port of said second proportional adder/subtracter, and is also coupled to the input port of said type 2 compressor, whereby said speaker driving circuit can be used to emulate vacuum tube amplifiers, to achieve sound effects, or to protect speakers from damaging from excessive cone excursion, or any combination of them.

18. A circuit according to claim 13, where said type 2 compressor comprises a triode or triode emulator.

19. A circuit according to claim 13, where said type 2 compressor comprises a type 1 compressor and a proportional adder/subtracter.

20. A circuit according to claim 13, where said type 3 expander comprises a type 1 expander and a bass low pass filter.
